(19) United States
(12) Patent Application Publication
(10) Pub. No.: US 2014/0215497 A1
(43) Pub. Date: Jul. 31, 2014

(54) Mobile Terminal and Method for Adjusting Operation Load Thereof

(71) Applicant: Hanlin Guo, Huizhou City (CN)

(72) Inventor: Hanlin Guo, Huizhou City (CN)

(73) Assignee: HUIZHOU TCL MOBILE COMMUNICATIONS CO., LTD., Huizhou City (CN)

(21) Appl. No.: 14/124,346

(22) PCT Filed: Aug. 27, 2012
(86) PCT No.: PCT/CN2012/080638

§ 371 Date: Dec. 6, 2013

(30) Foreign Application Priority Data
Oct. 9, 2011 (CN) 201110303626.6

(51) Int. Cl. G06F 9/48

(52) U.S. Cl. CPC G06F 9/48
USPC 719/320

(57) ABSTRACT

A method for adjusting operation load of a mobile terminal is disclosed in the present invention, and the method comprises a step of acquiring a processor clock speed frequency, a battery remaining capacity or a processor temperature; a step of determining whether the processor clock speed frequency is higher than a first predetermined threshold value, whether the battery remaining capacity is lower than a second predetermined threshold value, or whether the processor temperature is higher than a third predetermined threshold value; a step of closing the application program is executed through a driver layer of the mobile terminal in accordance with the strategy to release resource and reduce the processor clock speed frequency if any one or all of the conditions above are yes.

### FIELD OF THE DISCLOSURE

The present invention relates to a field of mobile terminal technology, and more particularly relates to a mobile terminal and a method for adjusting operation load thereof.

### BACKGROUND OF THE DISCLOSURE

With advancements of hardware specifications of smart phones, the processor clock speed and operation ability of the smart phones are continuously increasing. In addition, in order to satisfy the requirements of structural design, appearance, and size for the general users, the design of the cellular phones is focused on being light-weight and thin, but the thermal dispersion thereof is difficult to consider at the same time. The heat generation of the cellular phone processor is directly realized on the shell of the cellular phone. Therefore, the heat is generated on the shell of the cellular phone causing the shell to be overheating, and the life time of the battery is shortened.

The present solution provides a way to prevent overheating on the cellular phone which is to adjust the clock speed of the central processor unit (CPU), but directly forcing the processor clock speed to reduce would cause the system to be unstable. If many application programs are currently operated in the cellular phone, the system would collapse or crash.

Moreover, because all of the programs are application software, which are installed in the mobile terminal in a way of Application Package File (APK), the system cannot close these application programs wisely.

### SUMMARY OF THE DISCLOSURE

One main technical problem solved in the present invention is to provide a mobile terminal and a method for adjusting operating loading thereof The method can adjust the processor clock speed frequency of the mobile terminal to keep the mobile terminal in the proper working parameters so as to guarantee the stability of the system.

In order to solve the technical problem described above, one technical propose provided in the present invention is: a method for adjusting operation load of a mobile terminal and the method comprises:

A step of detecting a processor clock speed frequency, a battery remaining capacity or a processor temperature;

A step of acquiring the processor clock speed frequency, the battery remaining capacity or the processor temperature and the processor temperature is obtained by a temperature sensor;

A step of determining whether the processor clock speed frequency is higher than a first predetermined threshold value, whether the battery remaining capacity is lower than a second predetermined threshold value, or whether the processor temperature is higher than a third predetermined threshold value;

A step of generating a strategy for adjusting the processor clock speed frequency if any one or all of the conditions above are yes and the strategy is to calculate to acquire the application programs, which are required to be closed;

A step of closing the application program is executed through a driver layer of the mobile terminal in accordance with the strategy to release resource and reduce the processor clock speed frequency.

Amongst, before the step of detecting processor clock speed frequency, battery remaining capacity or a processor temperature, comprising:

A step of acquiring or setting the first predetermined threshold value, the second predetermined threshold value or the third predetermined threshold value.

Amongst, the step of closing the application program is executed through a driver layer of the mobile terminal in accordance with the strategy to release resource and reduce the processor clock speed frequency, comprising:

A step of determining whether the application program is an essential application program, if no, then the application program is closed directly, if yes, then the mobile terminal provides an application program list for a user to decide whether to close the application program if the application program is an essential application program.

Amongst, the step of acquiring the processor clock speed frequency, the battery remaining capacity or the processor temperature, comprising:

The processor clock speed frequency is acquired by a message transfer mechanism of an operating system.

Amongst, the step of acquiring the processor clock speed frequency, the battery remaining capacity or the processor temperature, comprising:

The processor clock speed frequency is acquired by a system application programming interface.

Amongst, the step of acquiring the processor clock speed frequency, the battery remaining capacity or the processor temperature, comprising:

The battery remaining capacity is acquired by a system application programming interface.

In order to solve the technical problem above, another technical solution provide in the present invention is: a method for adjusting operation load of a mobile terminal is provided and the method comprises: detecting a processor clock speed frequency, a battery remaining capacity or a processor temperature; acquiring the processor clock speed frequency, the battery remaining capacity or the processor temperature; determining whether the processor clock speed frequency is higher than a first predetermined threshold value, whether the battery remaining capacity is lower than a second predetermined threshold value, or whether the processor temperature is higher than a third predetermined threshold value; generating a strategy for adjusting the processor clock speed frequency if any one or all of the conditions above are yes and the strategy is to calculate which of the application programs of the mobile terminal required to be closed; closing the application program in accordance with a driver layer of the mobile terminal by the strategy to release resource and reduce the processor clock speed frequency.

Amongst, before the step of detecting processor clock speed frequency, battery remaining capacity or a processor temperature, comprising:

A step of acquiring or setting the first predetermined threshold value, the second predetermined threshold value or the third predetermined threshold value.

Amongst, the step of closing the application program is executed through a driver layer of the mobile terminal in accordance with the strategy to release resource and reduce the processor clock speed frequency, comprising: determining whether the application program is an essential application program, if no, then the application program is closed directly, if yes, then the mobile terminal provides an application program list for a user to decide whether to close the application program if the application program is an essential application program.

Amongst, the step of closing the application program is executed through a driver layer of the mobile terminal in accordance with the strategy to release resource and reduce the processor clock speed frequency, comprising: closing the application program through a driver layer of the mobile terminal.

Amongst, the step of acquiring the processor clock speed frequency, the battery remaining capacity or the processor temperature, the acquiring method is to acquire the processor clock speed frequency, the battery remaining capacity or the processor temperature by a message transfer mechanism of an operating system and a driver program.

In order to solve the technical problem above, another technical solution provide in the present invention is a mobile terminal is provided and the mobile terminal comprises: a processor clock speed detecting module configured for detecting a processor working frequency, which is clock speed frequency; a power detecting module configured for detecting a battery remaining capacity; a processor temperature detecting module configured for detecting a processor temperature; an acquiring module configured for acquiring the processor clock speed frequency, the battery remaining capacity or the processor temperature; a first determining module configured for determining whether the processor clock speed frequency is higher than a first predetermined threshold value, whether the battery remaining capacity is lower than a second predetermined threshold value, or whether the processor temperature is higher than a third predetermined threshold value; a calculating module configured for generating a strategy for adjusting the processor clock speed frequency and the strategy is to calculate which of the application programs of the mobile terminal required to be closed; a processor frequency adjusting module configured for releasing resource and reducing the processor clock speed frequency in accordance with the strategy for closing the application programs.

Amongst, the mobile terminal comprises: a threshold module configured for acquiring or setting the first predetermined threshold value, the second predetermined threshold value or the third predetermined threshold value.

Amongst, the processor frequency adjusting module comprises: a second determining module configured for determining whether the application program is an essential application program before closing the application program, if no, then the application program is closed directly, if yes, then the mobile terminal provides an application program list for a user to decide whether to close the application program if the application program is an essential application program.

Amongst, the processor frequency adjusting module closes the application program through a driver layer of the mobile terminal.

Amongst, the acquiring module acquires the processor clock speed frequency, the battery remaining capacity or the processor temperature by a message transfer mechanism of an operating system and a driver program.

The advantage of the present invention is: by comparing with the conventional solution to directly adjust the processor clock speed frequency, the present invention is to detect the processor clock speed frequency, the battery remaining capacity and the processor temperature and compare the processor clock speed frequency, the battery remaining capacity and the processor temperature with the predetermined threshold value. If the clock speed frequency is too high, the power is not enough or the temperature is too high, it is not direct to reduce the frequency of the processor but it is to calculate which of application programs of the mobile terminal are required to be closed to reduce the frequency to be the normal value. By the method describe above, the present invention can adjust the processor clock speed frequency of the mobile terminal to keep the mobile phone in the proper working parameters so as to guarantee the stability of the system.

### DESCRIPTION OF THE DRAWINGS

FIG. 1 is a flow chart illustrating a method for adjusting operation load of a mobile terminal in one embodiment of the present invention;

FIG. 2 is a flow chart illustrating a method for adjusting operation load of a mobile terminal in another embodiment of the present invention;

FIG. 3 is a structural view illustrating a mobile terminal in one embodiment of the present invention; and

FIG. 4 is a flow chart illustrating a strategy for acquiring adjusting operation load of a mobile terminal in one embodiment of the present invention.

### DETAILED DESCRIPTION OF THE PREFERRED EMBODIMENTS

The above-mentioned description of the present invention can be best understood by referring to the following detailed description of the preferred embodiments and the accompanying drawings.

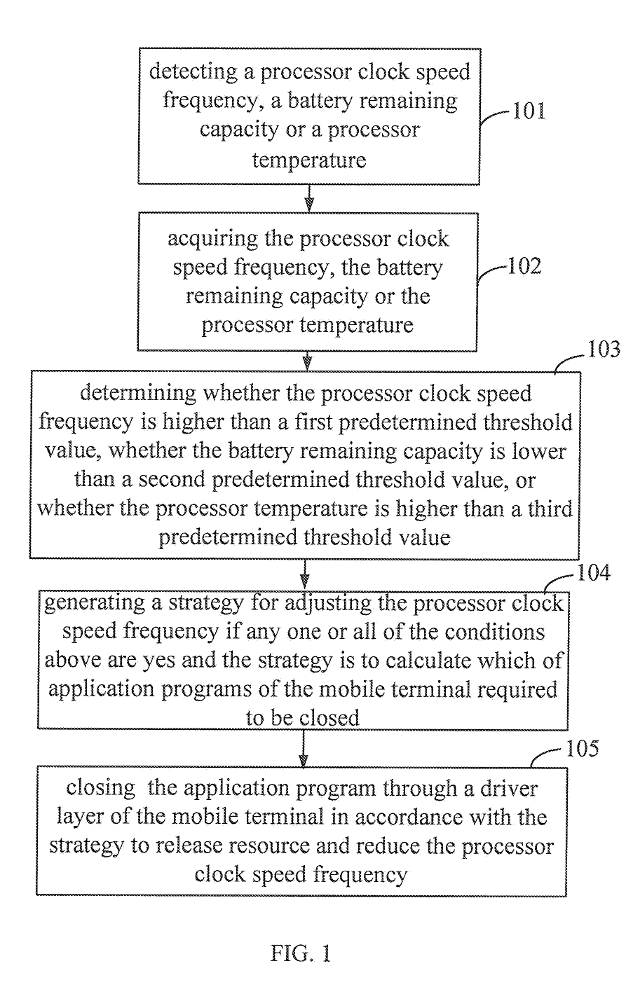

FIG. 1 is a flow chart illustrating a method for adjusting operation load of a mobile terminal in one embodiment of the present invention and the method includes the following steps:

In step 101, it is to detect a processor clock speed frequency, a battery remaining capacity or a processor temperature;

The detected parameters includes: the processor clock speed frequency, the battery remaining capacity or the processor temperature;

In step 102, it is to acquire the processor clock speed frequency, the battery remaining capacity or the processor temperature;

The method for acquiring each parameters is as the following: by a message transfer mechanism of an operating system or system application programming interface (API), the processor clock speed frequency can acquire a working status of the processor, such as the current working frequency of the processor; the battery remaining capacity is to acquire a power information by the system API; the processor temperature is to acquire a real time temperature of the processor chip by adding a temperature sensor.

In step 103, it is to determine whether the processor clock speed frequency is higher than a first predetermined threshold value, whether the battery remaining capacity is lower than a second predetermined threshold value, or whether the processor temperature is higher than a third predetermined threshold value;

The first predetermined threshold value is the highest warning value of the processor clock speed frequency, the second predetermined threshold value is a warning value of the battery remaining capacity, and the third predetermined threshold value is the warning value of the processor temperature. The status values in each of the current parameters are acquired to compare with the corresponding threshold values.

In step 104, it is to generate a strategy for adjusting the processor clock speed frequency if any one or all of the conditions above are yes and the strategy is to calculate which of application programs of the mobile terminal required to be closed;

When the processor clock speed frequency is higher than the first predetermined threshold value, the battery remaining capacity is lower than the second predetermined threshold value, or the processor temperature is higher than the third predetermined threshold value and it is meaning that the processor clock speed frequency is too high, the power is not enough or the processor temperature is too high, the strategy for adjusting the processor clock speed frequency is calculated and the strategy is to calculate which of the application programs of the mobile terminal required to be closed.

In step 105, it is to close the application program through a driver layer of the mobile terminal in accordance with the strategy to release resource and reduce the processor clock speed frequency.

After receiving the strategy for adjusting the processor clock speed frequency, it is to determine whether the application program is an essential application program, if no, then the application is closed directly, if yes, then the mobile terminal provides an application program list for a user to decide whether to close the application program if the application program is an essential application program. For example, the mobile terminal automatically closes some application programs, which will not affect the stability of the system, to release resource through a driver layer of the mobile terminal. If some application programs are significant or currently in use, such as network connection for background, a list is automatically generated for a user to decide whether to close the application program if the application program is an essential application program at the same time. When the application programs are completely closed, it is to force the processor to adjust the frequency to lower than the warning value by adjusting the system API or the message transfer mechanism. After the adjustment is done, the detection of the status in each of parameters is continued. If the frequency adjusting condition is satisfied, the adjustment is continued.

Amongst, the present invention is a software solution and can be achieved by software source code.

The present invention firstly detects the processor clock speed frequency, the battery remaining capacity or the processor temperature, and the detected clock speed frequency, power or temperature value is compared with the predetermined warning value. If the clock speed frequency is too high, the power is not enough or the temperature value is too high, it is not to reduce the frequency of the processor directly, but it is to calculate which of the application programs of the mobile terminal required to be closed. The frequency of the processor is reduced by closing the application programs to release resource. By the method described above, the present invention can adjust the processor clock speed frequency of the mobile terminal and the mobile terminal is maintained under a proper working parameter and stability of the system is guaranteed at the same time.

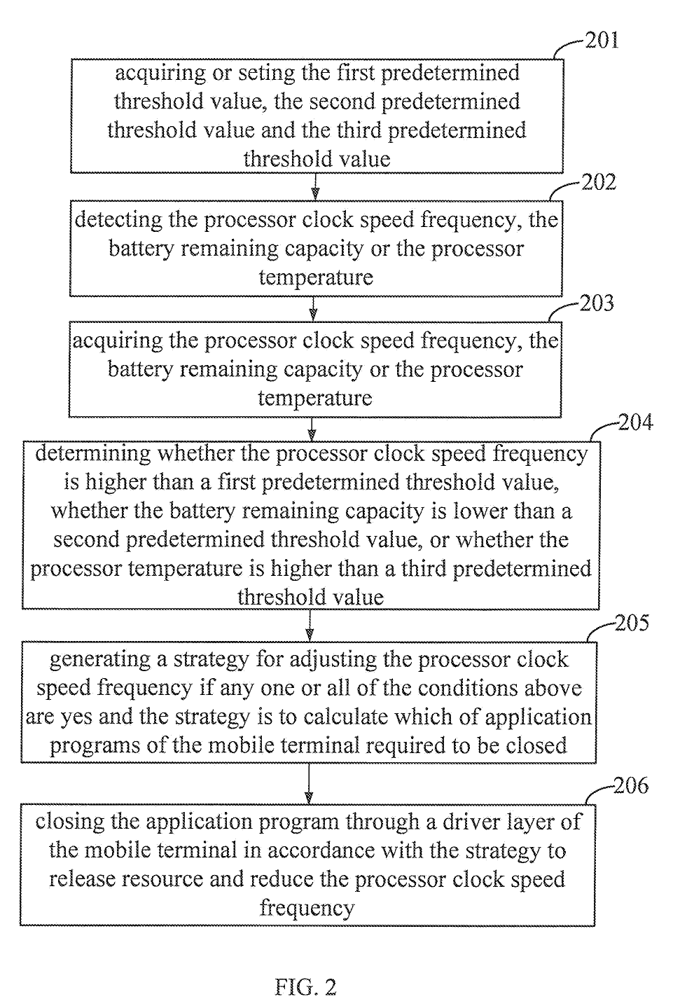

FIG. 2 is a flow chart a method for adjusting operation load of a mobile terminal in another embodiment of the present invention and the method includes step 201, step 202, step 203, step 204, step 205 and step 206. Amongst, steps 202-206 are the same as the steps 101-105 except step 201, and the description of the steps 202-206 are omitted herein.

In step 201, it is to acquire or set the first predetermined threshold value, the second predetermined threshold value and the third predetermined threshold value;

At first, a main function of the mobile terminal provides an icon of a shortcut and the user enters therein to choose whether to activate the automatic adjustment of the processor clock speed and also set the monitoring rule at the same time. The parameters in the monitoring rule includes the processor clock speed frequency, the battery remaining capacity or the processor temperature, such as setting the highest warning value of the processor clock speed frequency, the warning value of the processor temperature, the warning value of the battery power, the normal value of the processor clock speed frequency and so on. The first predetermined threshold value is the highest warning value of the processor clock speed frequency, the second predetermined threshold value is the warning value of the battery remaining capacity and the third predetermined threshold value is the warning value of the processor temperature.

The first predetermined threshold value, the second predetermined threshold value and the third predetermined threshold value can also be the threshold values defined by the mobile terminal when the mobile terminal is released in the market.

In step 202, it is to detect the processor clock speed frequency, the battery remaining capacity or the processor temperature;

In step 203, it is to acquire the processor clock speed frequency, the battery remaining capacity or the processor temperature;

In step 204, it is to determine whether the processor clock speed frequency is higher than the first predetermined threshold value, whether the battery remaining capacity is lower than the second predetermined threshold value, or whether the processor temperature is higher than the third predetermined threshold value;

In step 205, it is to generate a strategy for adjusting the processor clock speed frequency if any one or all of the conditions above are yes and the strategy is to calculate which of the application programs of the mobile terminal required to be closed;

In step 206, it is to close the application program through a driver layer of the mobile terminal in accordance with the strategy to release resource and reduce the processor clock speed frequency

The present invention firstly detects the processor clock speed frequency, the battery remaining capacity or the processor temperature, and the detected clock speed frequency, power or temperature value is compared with the predetermined warning value. If the clock speed frequency is too high, the power is not enough or the temperature value is too high, it is not to reduce the frequency of the processor directly, but it is to calculate which of the application programs of the mobile terminal required to be closed. The frequency of the processor is reduced by closing the application programs to release resource. By the method described above, the present invention can adjust the processor clock speed frequency of the mobile terminal and the mobile terminal is maintained under a proper working parameter and the stability of the system is guaranteed at the same time.

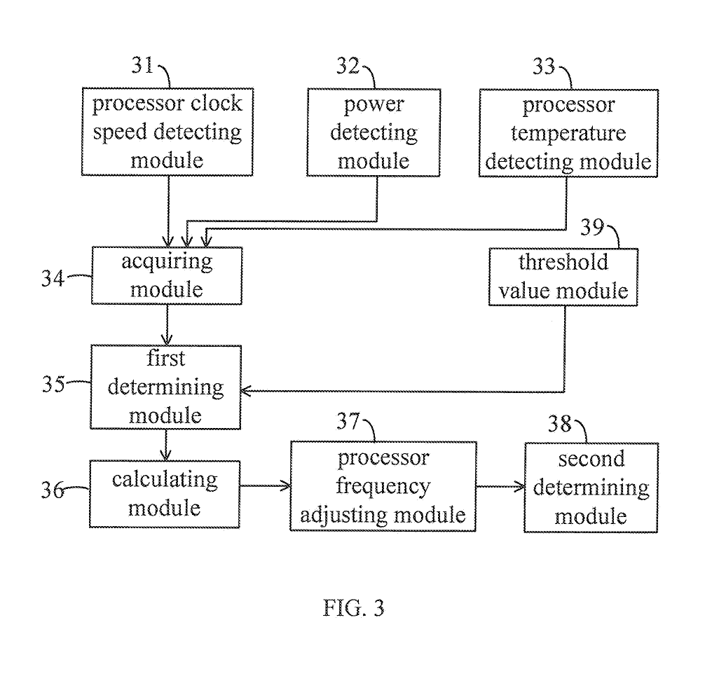

FIG. 3 is a structural view illustrating a mobile terminal in one embodiment of the present invention. As shown in FIG. 3, the mobile terminal includes a processor clock speed detecting module 31, a power detecting module 32, a processor temperature detecting module 33, an acquiring module 34, a first determining module 35, a calculating module 36, a processor frequency adjusting module 37, a second determining module 38 and a threshold value module 39.

Amongst, the processor clock speed detecting module 31 is configured for detecting a processor working frequency, which is a clock speed frequency; the power detecting module 32 is configured for detecting a battery remaining capacity; the processor temperature detecting module 33 is configured for detecting a processor temperature; the acquiring module 34 is configured for acquiring the processor clock speed frequency, the battery remaining capacity or the processor temperature; the first determining module 35 is configured for determining whether the processor clock speed frequency is higher than a first predetermined threshold value, whether the battery remaining capacity is lower than a second predetermined threshold value, or whether the processor temperature is higher than a third predetermined threshold value; the calculating module 36 is configured for generating a strategy for adjusting the processor clock speed frequency and the strategy is to calculate which of the application programs of the mobile terminal required to be closed; the processor frequency adjusting module 37 is configured for releasing resource and reducing the processor clock speed frequency in accordance with the strategy for closing the application programs; the second determining module 38 is configured for determining whether the application program is an essential application program before closing the application program, if no, then the application program is closed directly, if yes, then the mobile terminal provides an application program list for a user to decide whether to close the application program if the application program is an essential application program; the threshold module 39 is configured for acquiring or setting the first predetermined threshold value, the second predetermined threshold value or the third predetermined threshold value.

At first, a main function of the mobile terminal provides an icon of a shortcut and the user enters therein to choose whether to activate the automatic adjustment of the processor clock speed and also set the monitoring rule at the same time. The parameters in the monitoring rule includes the processor clock speed frequency, the battery remaining capacity or the processor temperature, such as setting the highest warning value of the processor clock speed frequency, the warning value of the processor temperature, the warning value of the battery power, the normal value of the processor clock speed frequency and so on. The threshold value 39 acquires or sets the first predetermined threshold value (the highest warning value of the processor clock speed frequency), the second predetermined threshold value (the warning value of the battery remaining capacity) and the third predetermined threshold value (the warning value of the processor temperature). After the frequency adjustment is automatically activated, the processor clock speed frequency detecting module 31 detects the processor working frequency, which is the clock speed frequency; the power detecting module 32 is to detect the battery remaining capacity; the processor temperature detecting module 33 is to detect the processor temperature. The method for acquiring each parameters is as the following: by a message transfer mechanism of an operating system or system application programming interface (API), the processor clock speed frequency can acquire a working status of the processor, such as the current working frequency of the processor; the battery remaining capacity is to acquire a power information by the system API; the processor temperature is to acquire a real time temperature of the processor chip by adding a temperature sensor. The acquiring module 34 is to acquire the status values in each of parameters. The first determining module 35 is to compare the status values with the warning values in each of the parameters in the corresponding monitoring rule. If the comparing result is: the processor clock speed frequency is too high, the power is not enough, or the processor temperature is too high, the frequency reducing operation of the mobile terminal is automatically activated. Firstly; the calculating module 36 will calculate which of application programs of the mobile terminal are required to be closed to reduce the frequency to be the normal value, and the adjusting rule is automatically calculated and the information instruction is transmitted to the processor frequency adjusting module 37. After the processor frequency adjusting module 37 receives the information instruction, the second determining module 38 determines whether the application programs, which are required to be closed, are the essential application programs, if no, then the system is directly closed, if yes, then the system provides an application program list for the user to choose the application programs to close. For example, the mobile terminal automatically closes some application programs, which will not affect the stability of the system, to release resource through a driver layer of the mobile terminal. If some application programs are significant or currently in use, such as network connection for background, a list is automatically generated for a user to choose. These chosen application programs are closed at the same time. When the application programs are completely closed, it is to force the processor to adjust the frequency lower than the warning value by adjusting the system API or the message transfer mechanism. After the adjustment is done, the detection of the status of each of parameters is continued. If the frequency adjusting condition is satisfied, the adjustment is continued.

The present invention is to detect each of the parameters in the mobile terminal. When the adjustment condition is satisfied, the command and information is transmitted by the message transfer mechanism of the operating system and the driver program to quickly adjust the processor clock speed manually or automatically. The inessential application programs are closed to save the system resource, extend the standby time, reduce the heat generation of the mobile terminal and enhance the user experience.

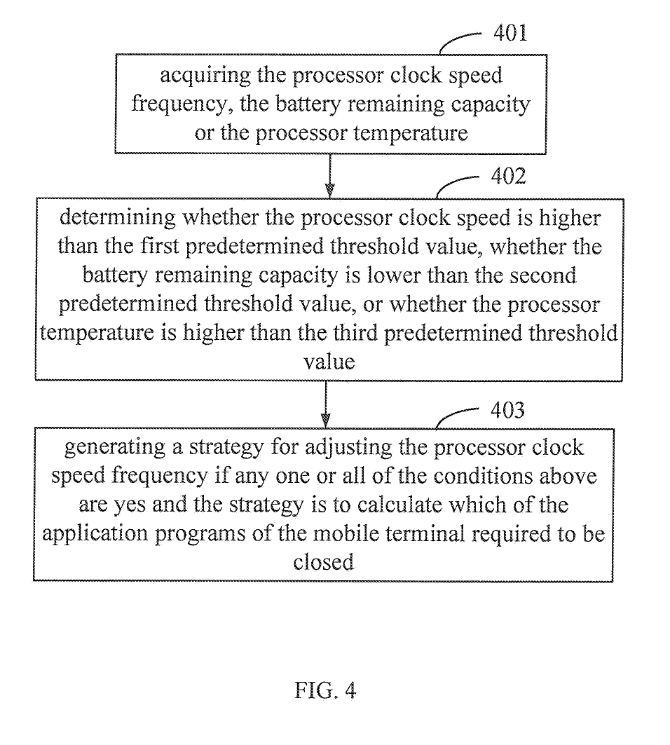

FIG. 4 is a flow chart illustrating a strategy for acquiring operation load adjustment in one embodiment of the present invention and the steps of the strategy is as the following:

In step 401, it is to acquire the processor clock speed frequency, the battery remaining capacity or the processor temperature;

The acquired parameters include: the processor clock speed frequency, the battery remaining capacity or the processor temperature. The acquiring method of the parameters is as the following: by a message transfer mechanism of the operating system or system application programming interface (API), the processor clock speed frequency can acquire a working status of the processor, such as the current working frequency of the processor; the processor temperature is to acquire a real time temperature of the processor chip by adding a temperature sensor.

In step 402, it is to determine whether the processor clock speed is higher than the first predetermined threshold value, whether the battery remaining capacity is lower than the second predetermined threshold value, or whether the processor temperature is higher than the third predetermined threshold value;

Before steps 401 and 402, a main function of the mobile terminal firstly provides an icon of a shortcut and the user enters therein to choose whether to activate the automatic adjustment of the processor clock speed and set the monitoring rule. The parameters in the monitoring rule includes the processor clock speed frequency, the battery remaining capacity or the processor temperature, such as setting the highest warning value of the processor clock speed frequency, the warning value of the processor temperature, the warning value of the battery power, the normal value of the processor clock speed frequency and so on. The first predetermined threshold value is the highest warning value of the processor clock speed frequency, the second predetermined threshold value is the warning value of the battery remaining capacity and the third predetermined threshold value is the warning value of the processor temperature.

The first predetermined threshold value, the second predetermined threshold value and the third predetermined threshold value can also be the threshold values defined by the mobile terminal when the mobile terminal is released in the market.

Step 402 is a comparing and determining step and is to compare the current status values of the parameters with the corresponding threshold values.

In step 403, it is to generate a strategy for adjusting the processor clock speed frequency if any one or all of the conditions above are yes and the strategy is to calculate which of the application programs of the mobile terminal required to be closed.

If any one of the parameters is over the warning value defined by the user, the information thereof is transmitted to the application manager. The application manager will calculate each of resource holding condition, such as the parameter of the processor resource holding percentage, the power consumption and so on, for all of the currently working application programs. The frequency adjusting strategy is comprehensively calculated to satisfy the monitoring rule and the strategy is to calculate which of the application programs of the mobile terminal required to be closed. The application programs are closed to release CPU resource so as to adjust the processor clock speed to the normal level. If the status values for any one of the parameters are lower than the warning values, the judgments in step 402 are no, then it is not to execute any operations.

The present embodiment is to acquire the processor clock speed frequency, the battery remaining capacity or the processor temperature and compare the processor clock speed frequency, the battery remaining capacity or the processor temperature with the predetermined threshold value. If the clock speed frequency is too high, the power is not enough or the temperature is too high, it is not to reduce the clock speed frequency directly but it is to calculate which application programs of the mobile terminal are required to be closed. The processor frequency is reduced by closing the application program to release the resource. By the method described above, the present invention can adjust the processor clock speed frequency of the mobile terminal and the mobile terminal can be maintained in the proper working parameters so as to guarantee the stability of the system.

As described above, the present invention has been described with preferred embodiments thereof and it is understood that many changes and modifications to the described embodiments can be carried out without departing from the scope and the spirit of the disclosure that is intended to be limited only by the appended claims.

1-16. (canceled)

17. A method for adjusting operation load of a mobile terminal, comprising:
acquiring at least one detecting parameter from the mobile terminal;
comparing each one of the detecting parameter with a predetermined threshold value to obtain a comparison result;
determining which of application programs of the mobile terminal is required to be closed in accordance with the comparison result; and
closing an application program to release resource and reduce the processor clock speed frequency if the application program is determined to be closed.

18. The method according to claim 17, wherein before the step of acquiring the at least one detecting parameter from the mobile terminal, comprises:
acquiring or setting the predetermined threshold value.

19. The method according to claim 17, wherein the step of closing the application program to release resource and reduce the processor clock speed frequency comprises:
determining whether the application program is an essential application program; and
closing the application program directly if the application program is not the essential application program, or providing an application program list by the mobile terminal for a user to decide whether to close the application program if the application program is the essential application program.

20. The method according to claim 17, wherein the detecting parameter is selected from the group consisting of a processor clock speed frequency, a battery remaining capacity and a processor temperature.

21. The method according to claim 20, wherein the step of acquiring the at least one detecting parameter from the mobile terminal comprises:
acquiring the processor clock speed frequency by a message transfer mechanism of an operating system.

22. The method according to claim 20, wherein the step of acquiring the at least one detecting parameter from the mobile terminal, comprises:
acquiring the processor clock speed frequency by a system application programming interface (API); and
acquiring the processor temperature by a temperature sensor.

23. The method according to claim 20, wherein the step of acquiring the at least one detecting parameter from the mobile terminal comprises:
acquiring the battery remaining capacity by a system API.

24. The method according to claim 17, wherein the step of closing the application program to release resource and reduce the processor clock speed frequency is executed through a driver layer of the mobile terminal.

25. A method for adjusting operation load of a mobile terminal, comprising:
detecting a processor clock speed frequency, a battery remaining capacity or a processor temperature;
acquiring the processor clock speed frequency, the battery remaining capacity or the processor temperature;
determining whether the processor clock speed frequency is higher than a first predetermined threshold value, whether the battery remaining capacity is lower than a second predetermined threshold value, or whether the processor temperature is higher than a third predetermined threshold value;
generating a strategy for adjusting the processor clock speed frequency if any one or all of the conditions above are yes and the strategy is to calculate which of application programs of the mobile terminal required to be closed; and
closing the application program in accordance with the strategy to release resource and reduce the processor clock speed frequency.

26. The method according to claim 25, wherein before the step of detecting the processor clock speed frequency, the battery remaining capacity or the processor temperature, comprises:
acquiring or setting the first predetermined threshold value, the second predetermined threshold value or the third predetermined threshold value.

27. The method according to claim 25, wherein the step of closing the application program through the driver layer in accordance with the strategy to release resource and reduce the processor clock speed frequency, comprises: determining whether the application program is an essential application program, if no, then the application program is closed directly, if yes, then the mobile terminal provides an application program list by the mobile terminal for a user to decide whether to close the application program if the application program is the essential application program.

28. The method according to claim 25, wherein the step of closing the application program through the driver layer in accordance with the strategy to release resource and reduce the processor clock speed frequency, comprises: closing the application program through a driver layer of the mobile terminal.

29. The method according to claim 25, wherein the step of acquiring the processor clock speed frequency, the battery remaining capacity or the processor temperature, the acquiring method is to acquire the processor clock speed frequency, the battery remaining capacity or the processor temperature by a message transfer mechanism of the operating system and the driver program.

30. A mobile terminal, comprising:
a processor clock speed detecting module configured for detecting a processor working frequency, which is a clock speed frequency;
a power detecting module configured for detecting a battery remaining capacity;
a processor temperature detecting module configured for detecting a processor temperature;
an acquiring module configured for acquiring the processor clock speed frequency, the battery remaining capacity or the processor temperature;
a first determining module configured for determining whether the processor clock speed frequency is higher than a first predetermined threshold value, whether the battery remaining capacity is lower than a second predetermined threshold value, or whether the processor temperature is higher than a third predetermined threshold value;
a calculating module configured for generating a strategy for adjusting the processor clock speed frequency and the strategy is to calculate which of application programs of the mobile terminal required to be closed;
a processor frequency adjusting module configured for releasing resource and reducing the processor clock speed frequency in accordance with the strategy for closing the application programs.

31. The mobile terminal according to claim 30, wherein the mobile terminal comprises:
a threshold module configured for acquiring or setting the first predetermined threshold value, the second predetermined threshold value or the third predetermined threshold value.

32. The mobile terminal according to claim 30, wherein the processor frequency adjusting module comprises: a second determining module configured for determining whether the application program is an essential application program before closing the application program, if no, then the program is closed directly, if yes, then the mobile terminal provides an application program list for the user to decide whether to close the application program if the application program is the essential application program.

33. The mobile terminal according to claim 30, wherein the processor frequency adjusting module closes the application program through a driver layer of the mobile terminal.

34. The mobile terminal according to claim 30, wherein the acquiring module acquires the processor clock speed frequency, the battery remaining capacity or the processor temperature by a message transfer mechanism of the operating system and the driver program.
